(19) United States
(12) Patent Application Publication
(10) Pub. No.: US 2012/0092186 A1
(43) Pub. Date: Apr. 19, 2012

(54) WIRELESS COMMUNICATION DEVICE

(75) Inventor: Chung-Chiu Lai, Hsinchu County (TW)

(73) Assignee: GEMTEK TECHNOLOGY CO., LTD., Hsinchu (TW)

(21) Appl. No.: 12/954,622

(22) Filed: Nov. 25, 2010

(30) Foreign Application Priority Data
Oct. 18, 2010 (TW) 99135460

(51) Int. Cl. G08G 1/09

(52) U.S. Cl. 340/905

(57) ABSTRACT

A wireless communication device adapted for transmitting and receiving information in a wireless access in vehicular environment (WAVE) is proposed. The wireless communication device includes a WAVE module. The WAVE module broadcasts a WAVE announcement frame as a beacon, where the beacon includes a WAVE service information element (WSIE), and the WSIE includes at least record information such as a vehicle number of a vehicle, in which the wireless communication device is located. Another wireless communication device is proposed, which exchanges respective record information with the neighboring vehicle(s) via a connection established between the wireless communication device and the neighboring vehicle(s) after at least a WAVE announcement frame of the neighboring vehicle(s) is received.

### CROSS-REFERENCE TO RELATED APPLICATION

This application claims the priority benefit of Taiwan application serial no. 99135460, filed on Oct. 18, 2010. The entirety of the above-mentioned patent application is hereby incorporated by reference herein and made a part of specification.

### BACKGROUND

1. Field of the Invention

The invention relates to a wireless communication device, and particularly, the invention relates to a wireless communication device used in a wireless access in vehicular environment (WAVE).

2. Description of Related Art

Presently, a vehicle communication technology gradually becomes mature and is widely applied in vehicles. According to such vehicle communication technology, a vehicle that is originally blocked from communicating with external entities and cannot interact with other vehicles is now capable of performing one-way information transmission or one-way information exchange to neighboring vehicles or base stations. For example, a wireless communication standard can be applied in the vehicular communication technology to effectively reduce cost of a vehicular communication device, so as to widely apply the vehicular communication technology in vehicles. However, according to the current vehicular communication technology, related information of neighboring vehicles is not effectively recorded. Therefore, how to record the related information of the neighboring vehicles without violating individual privacy of the drivers is an important issue to be developed.

### SUMMARY OF THE INVENTION

Accordingly, the invention is directed to a wireless communication device, which is operated in a wireless access in vehicular environment (WAVE), and allows neighboring vehicles to obtain related information of a present vehicle in a wireless communication approach. Alternatively, the wireless communication device further establishes connections with the wireless communication devices of the neighboring vehicles to safely and effectively exchange respective information.

An exemplary embodiment of the invention provides a wireless communication device adapted for transmitting and receiving information in a wireless access in vehicular environment (WAVE). The wireless communication device includes a WAVE module. The WAVE module broadcasts a WAVE announcement frame as a beacon, where the beacon includes a WAVE service information element (WSIE), and the WSIE includes at least record information such as a vehicle number of a vehicle in which the wireless communication device is located.

An exemplary embodiment of the invention provides a wireless communication device adapted for transmitting and receiving information in a wireless access in vehicular environment (WAVE). The wireless communication device includes a WAVE module. The WAVE module broadcasts a first WAVE announcement frame, and continually receives at least a second WAVE announcement frame broadcasted by at least a neighboring vehicle. The first WAVE announcement frame and the at least a second WAVE announcement frame are all beacons, and each one of the beacons includes a WAVE service information element (WSIE), and the WSIE includes at least record information.

According to the above descriptions, the exemplary embodiments of the invention provide a wireless communication device. The wireless communication device allows the neighboring vehicles obtaining related information of the present vehicle through a wireless communication approach, or the wireless communication device further establishes connections with the wireless communication devices of the neighboring vehicles to safely and effectively exchange respective information with each other. Moreover, the wireless communication device can also be connected to other devices of the vehicle to obtain related information, so as to correctly determine whether a collision event or a traffic accident occurs, and accordingly broadcast an emergency signal through the WAVE announcement frame when the collision event or the traffic accident occurs.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a systematic structure diagram of a wireless communication system according to an exemplary embodiment of the invention.

FIG. 2 is a functional block diagram illustrating a wireless communication device according to an exemplary embodiment of the invention.

FIG. 3 is a flowchart illustrating a wireless communication method according to an exemplary embodiment of the invention.

FIG. 4 is a flowchart illustrating another wireless communication method according to an exemplary embodiment of the invention.

FIG. 5 is a flowchart illustrating another wireless communication method according to an exemplary embodiment of the invention.

FIG. 6 is a flowchart illustrating another wireless communication method according to an exemplary embodiment of the invention.

### DETAILED DESCRIPTION OF DISCLOSED EMBODIMENTS

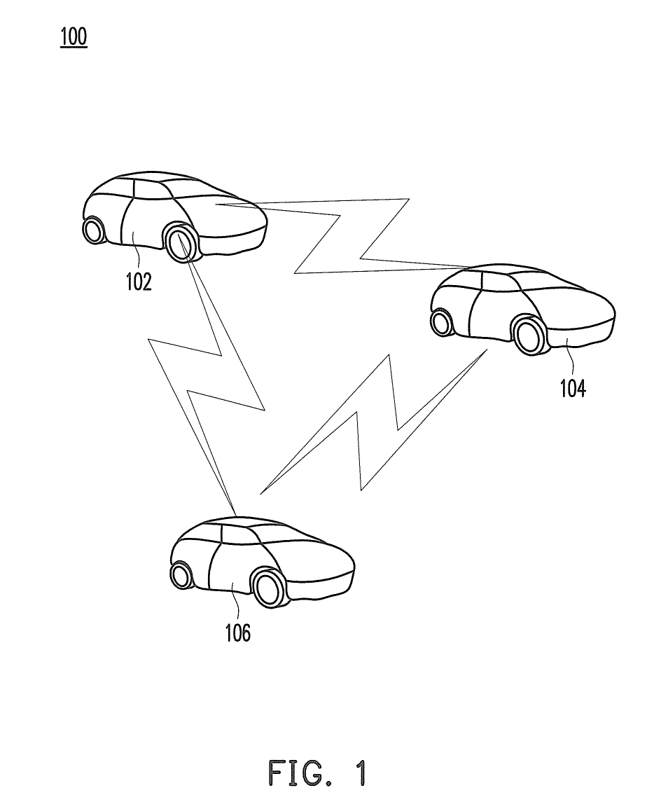

FIG. 1 is a systematic structure diagram of a wireless communication system 100 according to an exemplary embodiment of the invention. Referring to FIG. 1, the wireless communication system 100 is, for example, an IEEE 802.11p wireless communication system used in a vehicular environment. Each of vehicles in the wireless communication system 100, for example, a vehicle 102, a vehicle 104 and a vehicle 106 can establish peer-to-peer connections with neighboring vehicles through a wireless communication approach, so that the neighboring vehicles can obtain related information of the present vehicle. Alternatively, one vehicle (for example, the vehicle 102) can establish a connection with the neighboring vehicles (the vehicles 104 and 106) to exchange respective information. In the wireless communication system 100, if a distance between the vehicle 102 and the neighboring vehicle (for example, the vehicle 104) is greater than a distance threshold, the communication therebetween is stopped. In other embodiments, the vehicle 102 can also communicate with the neighboring vehicles through base stations (not shown) or wireless access points (not shown) in neighboring area, or receive broadcast beacons of the neighboring vehicles through a distributed wireless communication approach, so as to obtain the related information of the neighboring vehicles.

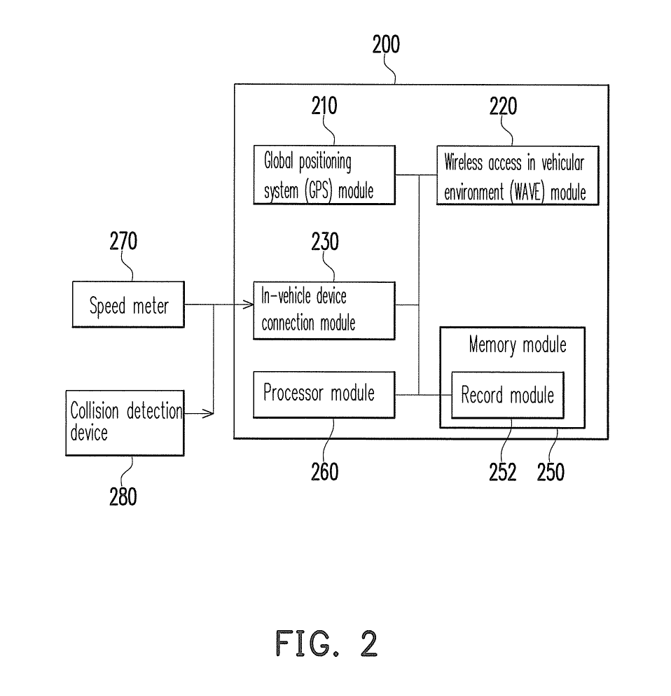

FIG. 2 is a functional block diagram illustrating a wireless communication device 200 according to an exemplary embodiment of the invention. The wireless communication device 200 is, an onboard unit (OBU) or a vehicle black box, which is used for recording driving information of the vehicle or related information of the vehicle during a moving process, for example, ever being neighbouring to other vehicles. The other devices of the vehicle in which the wireless communication device 200 is located, for example, a speed meter 270 and a collision detection device 280 can communicate with the wireless communication device 200 for exchanging data.

Referring to FIG. 2, the wireless communication device 200 includes a global positioning system (GPS) module 210, a wireless access in vehicular environment (WAVE) module 220, an in-vehicle device connection module 230, a memory module 250 and a processor module 260. The memory module 250 may include one or a plurality of memory units, and the processor module 260 may include one or a plurality of processing units. The memory module 250 may include at least one record module 252 and a database (not shown). The GPS module 210, the WAVE module 220, the in-vehicle device connection module 230, the memory module 250, the record module 252 and the processor module 260 are mutually connected. The memory module 250 may further include operating system software, a firmware module or other application programs, and the processor module 260 may execute these software or firmware, though these software or firmware are not the focus of the invention, so that detailed descriptions thereof are not introduced herein. The processor module 260 controls and coordinates the GPS module 210, the WAVE module 220, the in-vehicle device connection module 230, the memory module 250 and the record module 252.

As shown in FIG. 2, the WAVE module 220, the memory module 250, the record module 252 and the processor module 260 of the wireless communication device 200 are connected to the speed meter 270 and the collision detection device 280 through the in-vehicle device connection module 230 for receiving information or warning signals of the speed meter 270 and the collision detection device 280. The in-vehicle device connection module 230 can be connected to the speed meter 270 and the collision detection device 280 through a cable communication approach or a wireless communication approach. The in-vehicle device connection module 230 can also be connected to the other devices of the vehicle, for example, a text input device (not shown), an audio input device (not shown), an audio output device (not shown) or a visual output device (not shown).

In the present embodiment, if the in-vehicle device connection module 230 is connected to the other devices in the vehicle outside the wireless communication device 200 through the wireless communication approach, the in-vehicle device connection module 230 further includes a transceiver unit (not shown) and an antenna unit. The GPS module 210 includes a receiving antenna unit (not shown). The WAVE module 220 includes a transceiver unit (not shown) and a transceiver antenna unit (not shown). The transceiver unit of the WAVE module 220 includes a communication protocol stack module for controlling a communication protocol of an IEEE 802.11p standard, a transmission control protocol/Internet protocol (TCP/IP), or communication protocols or packet exchange formats of other application layers.

In the present exemplary embodiment, the GPS module 210 regularly or aperiodically receives signals from GPS satellites, and obtains a current position of the vehicle according to the received signals, i.e., obtains current GPS position information of the present vehicle. The record module 252 records the GPS position information of the present vehicle. By regularly or aperiodically recording the GPS position information of the present vehicle through the record module 252, the wireless communication device 200 can achieve a function of a driving recorder.

In the present exemplary embodiment, the WAVE module 220 is used for sending a WAVE announcement frame (i.e., a beacon), and vehicle communication devices of the neighboring vehicles can receive the beacon to obtain related information of the present vehicle, for example, a vehicle number, a current driving speed, a vehicle color, a vehicle load, a current passenger number, and etc. The vehicle number, the vehicle color and the vehicle load of the vehicle can be stored in the database of the memory module 250 through an input device of the vehicle. The current passenger number can be input to the database of the memory module 250 by the driver, or information of the current passenger number can be calculated according to reports of detectors disposed on seats of the vehicle. Moreover, the WAVE module 220 can obtain current driving speed information of the speed meter 270, and record the driving speed information in the record module 252.

The WAVE module 220 can further add information such as the vehicle number, the current driving speed, the vehicle color, the vehicle load and the current passenger number of the present vehicle into a WAVE service information element (WSIE) in the beacon. Namely, the beacon includes special record information, and the WAVE module 220 can add information such as the vehicle number, the current driving speed, the vehicle color, the vehicle load and the current passenger number of the present vehicle into the record information. However, the invention is not limited to the above description, and the related information of the present vehicle can also include other related information input by the driver.

Moreover, the WAVE module 220 can further establish corresponding WAVE connections with one or a plurality of neighboring vehicles after receiving WAVE announcement frames of the neighboring vehicles, and further exchange the respective record information. The WAVE module 220 can also establish a TCP/IP connection with one or a plurality of neighboring vehicles, and exchange the respective record information according to a cryptography (encryption) method, so as to prevent the record information from being captured by other communication devices. Moreover, according to the cryptography (encryption) method, related parameters of encryption and a encryption/decryption algorithm can be exchanged when the connection is established. Further, the WAVE module 220 exchanges record information with the neighboring vehicles, and the WAVE module 220 encrypts the record information to be transmitted to the neighboring vehicles, and decrypts the record information received from the neighboring vehicles.

Moreover, after the WAVE module 220 receives the record information of the WAVE announcement frames, the WAVE module 220 can store the record information into the record module 252 to facilitate subsequent data accessing. For example, if an accident of the present vehicle occurs, the ever-neighboured vehicles within a predetermined time of the accident can be determined by accessing the record information in the record module 252, so as to assist accident investigators to find suitable witness drivers or a suspected accident maker. Moreover, the WAVE module 220 can further store the GPS position information of the present vehicle obtained by the GPS module 210 and the record information in the record module 252, so as to clearly record a road location corresponding to the neighboring vehicle. In addition, the WAVE module 220 can further send a WAVE announcement frame as an emergency signal to the neighboring vehicles after receiving a warning signal of the collision detection device 280 (for example, due to a collision event of the present vehicle) for notifying the collision event, or send the emergency signal through the connected wireless communication devices of the neighboring vehicles.

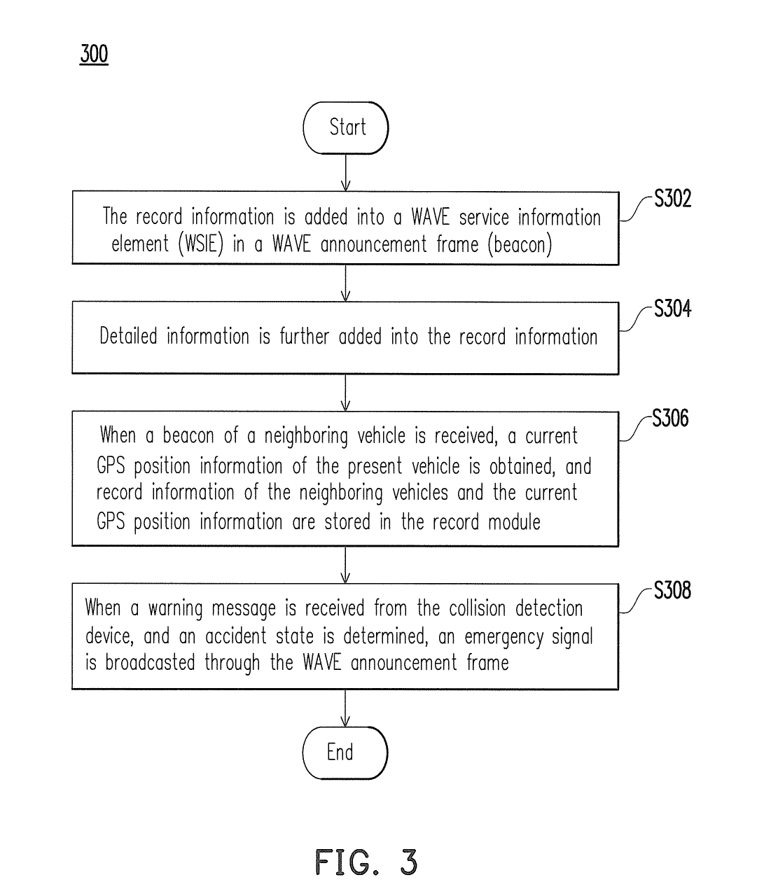

In other embodiment of the invention, the in-vehicle connection module 230 can be further connected to other devices, for example, a tyre pressure detection device (not shown), a brake system control device (not shown) or an engine control device (not shown). The tyre pressure detection device can send a warning signal to the WAVE module 220 when one or more tyres burst. The brake system control device can send a warning signal to the WAVE module 220 when a brake unit is malfunctioned and the driver cannot successfully brake the vehicle. The engine control device can send a warning signal to the WAVE module 220 when engine operation is abnormal. After the WAVE module 220 receives the above warning signals, the WAVE module 220 can send the WAVE announcement frame to the neighboring vehicles to notify these accidents may cause damages of the neighboring vehicles to the drivers of the neighboring vehicles. After the detailed functions of the wireless communication device 200 are introduced, a wireless communication method is further introduced in detail below with reference of FIG. 3 to FIG. 6.

FIG. 3 is a flowchart illustrating a wireless communication method 300 according to an exemplary embodiment of the invention. Referring to FIG. 2 and FIG. 3, the wireless communication method 300 is started from a step S302, and in the step S302, the WAVE module 220 adds record information into a WSIE in a WAVE announcement frame (beacon), and broadcast the WAVE announcement frame. In step S304, detailed information such as a vehicle number, a current driving speed, a vehicle color, a vehicle load and a current passenger number is further added into the record information. In step S306, when the WAVE module 220 receives one or a plurality of beacons of the neighboring vehicles, the WAVE module 220 obtains the record information of the neighboring vehicles from the beacon or the beacons, and obtains current GPS position information of the present vehicle, and stores the record information of the neighboring vehicles and the current GPS position information in the record module 252.

In step S308, when the WAVE module 220 receives a warning message from the collision detection device 280, and determines that the warning message indicates an accident state, the WAVE module 220 broadcasts an emergency signal through the WAVE announcement frame to notify the neighboring vehicles that the present vehicle has an accident (for example, the present vehicle has a collision event). After the step S308, the wireless communication method 300 is ended. It is noted that since the wireless communication device 200 is continually moved along with the present vehicle for approaching to different vehicles, in the wireless communication method 300, the step S302 to the step S306 are continually repeated.

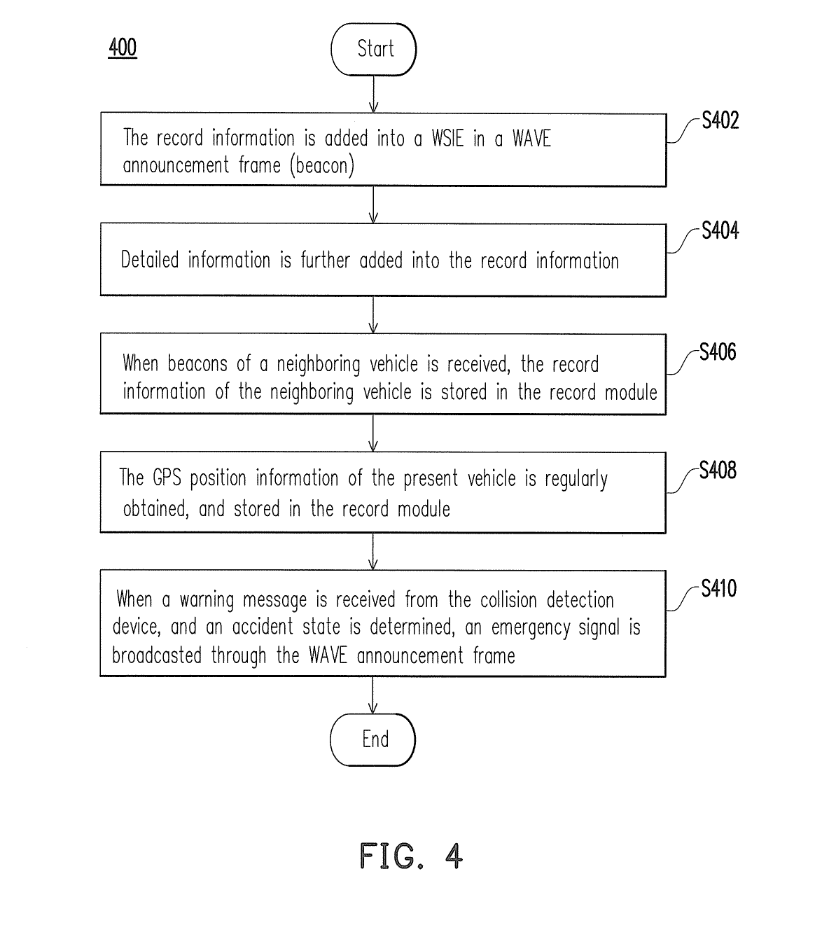

FIG. 4 is a flowchart illustrating another wireless communication method 400 according to an exemplary embodiment of the invention. The wireless communication method 400 is similar to the wireless communication method 300 of FIG. 3, and steps S402-S404 are the same to the steps S302-S304 of FIG. 3, so that detailed descriptions thereof are not repeated. Referring to FIG. 2 and FIG. 4, in step S406, when the WAVE module 220 receives one or a plurality of beacons of the neighboring vehicles, the WAVE module 220 stores the record information of the neighboring vehicles in the record module 252. In step S408, the WAVE module 220 periodically obtains the GPS position information of the present vehicle, and stores it in the record module 252. A step S410 is similar to the step S308, so that a detailed description thereof is not repeated. After the step S410, the wireless communication method 400 is ended. It is noted that since the wireless communication device 200 is continually moved along with the present vehicle for approaching to different vehicles, in the wireless communication method 400, the step S402 to the step S410 are continually repeated.

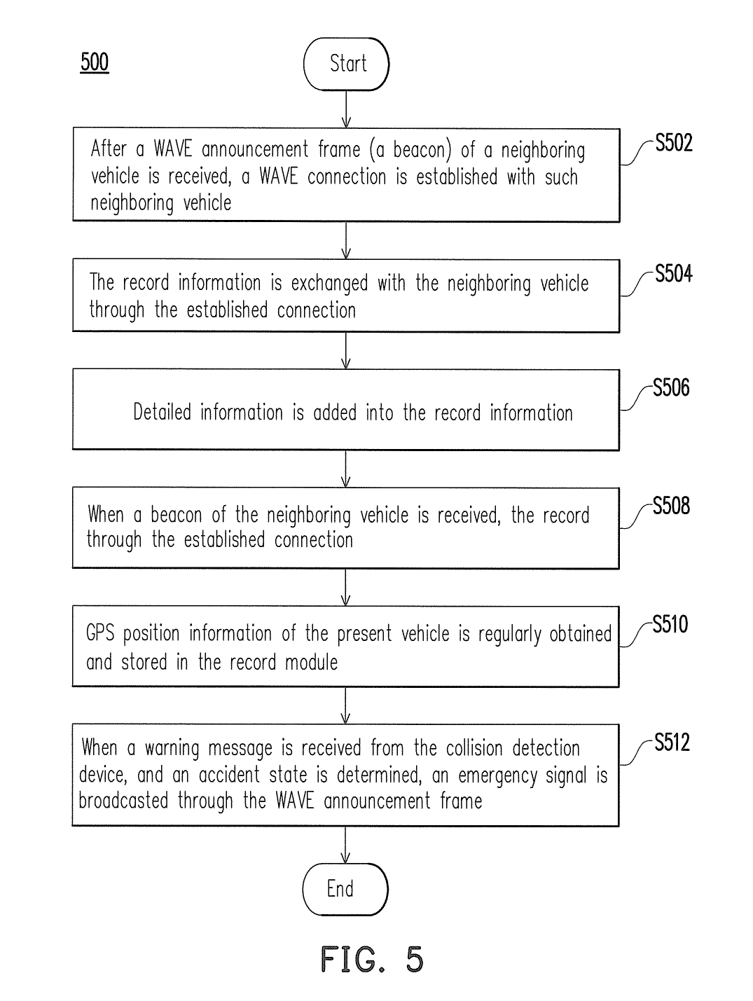

FIG. 5 is a flowchart illustrating another wireless communication method 500 according to an exemplary embodiment of the invention. Referring to FIG. 2 and FIG. 5, the wireless communication method 500 is started from a step S502, and in the step S502, the WAVE announcement frame is broadcasted. Moreover, after the WAVE module 200 receives a WAVE announcement frame (a beacon) of a neighboring vehicle, the WAVE module 200 establishes a WAVE connection with the neighboring vehicle. For example, referring to FIG. 1, if the WAVE module 220 on the vehicle 102 receives a beacon sent from the neighboring vehicle 104, the vehicle 102 can establish a connection with the vehicle 104. However, the invention is not limited thereto, and in the wireless communication method of the invention, the present vehicle can receive a plurality of WAVE announcement frames (beacons), and establish corresponding WAVE connections with a plurality of the neighboring vehicles.

In step S504, the WAVE module 220 exchanges the respective record information with the neighboring vehicles through the established connection. In step S506, the WAVE module 220 adds detailed information into the record information. In step S508, when the WAVE module 220 receives a beacon of the neighboring vehicle, the WAVE module 220 stores the record information of the neighboring vehicle in the record module 252. In step S510, the WAVE module 220 periodically obtains GPS position information of the present vehicle, and stores it in the record module 252. In step S512, after the WAVE module 220 receives a warning message from the collision detection device 280, and determines that the warning message indicates an accident state, the WAVE module 220 broadcasts the WAVE announcement frame as an emergency signal through the established connection with the neighboring vehicle to notify the neighboring vehicle that the present vehicle has an accident (for example, the present vehicle has a collision event). After the step S512, the wireless communication method 500 is ended. It is noted that since the wireless communication device 200 is continually moved along with the present vehicle for approaching to different vehicles, in the wireless communication method 500, the step S502 to the step S512 are continually repeated.

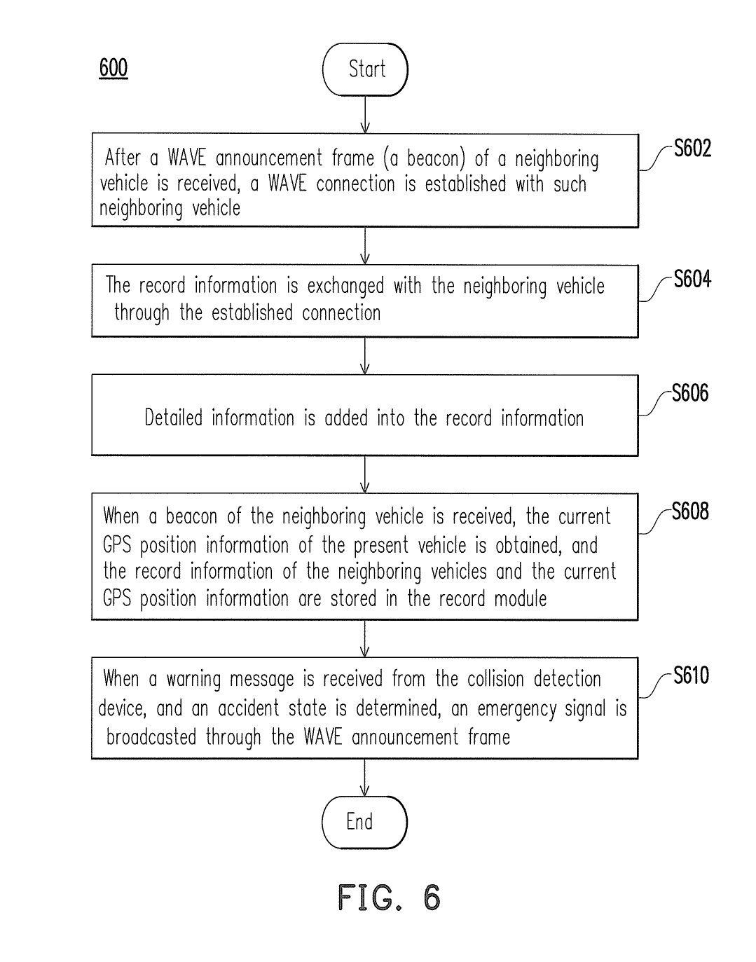

FIG. 6 is a flowchart illustrating another wireless communication method 600 according to an exemplary embodiment of the invention. The wireless communication method 600 is similar to the wireless communication method 500 of FIG. 5, and steps S602-S606 are the same to the steps S502-S506 of FIG. 5, so that detailed descriptions thereof are not repeated. Referring to FIG. 2 and FIG. 6, in step S608, when the WAVE module 220 receives one or a plurality of beacons of the neighboring vehicles, the WAVE module 220 first obtains the current GPS position information of the present vehicle, and stores the record information of the neighboring vehicles and the current GPS position information in the record module 252. A step S610 is similar to the step S512, so that a detailed description thereof is not repeated. After the step S610, the wireless communication method 600 is ended. It is noted that since the wireless communication device 200 is continually moved along with the present vehicle for approaching to different vehicles, in the wireless communication method 600, the step 6402 to the step S608 are continually repeated.

In summary, the exemplary embodiments of the invention provide a wireless communication device. The wireless communication device is adapted to operate in the WAVE, which allows the neighboring vehicles obtaining related information of the present vehicle through a wireless communication approach. Alternatively, the wireless communication device further establishes connections with the wireless communication devices of the neighboring vehicles to safely and effectively exchange information. Moreover, the wireless communication device can also be connected to other devices of the vehicle to obtain related information, so as to correctly determine whether a collision event or a vehicle accident is occurred, and accordingly broadcast an emergency signal through the WAVE announcement frame when a collision event or a traffic accident occurs. In this way, the wireless communication device can achieve functions similar to that of a driving recorder and a vehicle black box.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A wireless communication device, adapted for transmitting and receiving information in a wireless access in vehicular environment (WAVE), the wireless communication device comprising:
a WAVE module, configured for broadcasting a WAVE announcement frame, wherein the WAVE announcement frame is a beacon, the beacon comprises a WAVE service information element (WSIE), and the WSIE comprises at least record information.

2. The wireless communication device as claimed in claim 1, wherein the at least record information comprises at least a vehicle number of a vehicle, in which the wireless communication device is located.

3. The wireless communication device as claimed in claim 1, further comprising:
an in-vehicle device connection module, connected to the WAVE module, configured for connecting the WAVE module to at least a device of the vehicle, in which the wireless communication device is located;
a record module, connected to the WAVE module, configured for recording the at least record information and a vehicle number of the vehicle; and
a global positioning system (GPS) module, connected to the WAVE module and the record module, configured for obtaining current GPS position information of the vehicle.

4. The wireless communication device as claimed in claim 3, further comprising:
a speed meter, connected to the WAVE module and the record module through the in-vehicle device connection module, configured for providing current speed information of the vehicle to the WAVE module, wherein the record module records the current speed information of the vehicle.

5. The wireless communication device as claimed in claim 3, further comprising:
a collision detection device, connected to the WAVE module through the in-vehicle device connection module, configured for providing a warning message to the WAVE module when a collision event of the vehicle occurs, wherein the WAVE module sends the WAVE announcement frame to at least a neighboring vehicle to notify the collision event.

6. A wireless communication device, adapted for transmitting and receiving information in a wireless access in vehicular environment (WAVE), the wireless communication device comprising:
a WAVE module, configured for broadcasting a first WAVE announcement frame, and continually receiving at least a second WAVE announcement frame broadcasted by at least a neighboring vehicle, wherein the first WAVE announcement frame and the at least a second WAVE announcement frame are beacons, each one of the beacons comprises a WAVE service information element (WSIE), and the WSIE comprises at least record information.

7. The wireless communication device as claimed in claim 6, wherein the at least record information comprises at least a vehicle number of a vehicle, in which the wireless communication device is located.

8. The wireless communication device as claimed in claim 6, wherein, after the WAVE module receives the at least a second WAVE announcement frame, the WAVE module establishes one or a plurality of WAVE connections with the at least a neighboring vehicle.

9. The wireless communication device as claimed in claim 8, wherein, after the WAVE connection or the WAVE connections are established, the WAVE module and the at least a neighboring vehicle exchange the at least record information, wherein the WAVE module encrypts first record information sent to the at least a neighboring vehicle and decrypts second record information sent from the at least a neighboring vehicle.

10. The wireless communication device as claimed in claim 9, further comprising:
an in-vehicle device connection module, connected to the WAVE module, configured for connecting the WAVE module to at least a device of the vehicle, in which the wireless communication device is located;
a record module, connected to the WAVE module, configured for recording the at least record information and a vehicle number of the vehicle; and
a global positioning system (GPS) module, connected to the WAVE module and the record module, configured for obtaining current GPS position information of the vehicle.

11. The wireless communication device as claimed in claim 10, further comprising:
a speed meter, connected to the WAVE module and the record module through the in-vehicle device connection module, configured for providing current speed information of the vehicle to the WAVE module, wherein the record module records the current speed information of the vehicle.

12. The wireless communication device as claimed in claim 11, further comprising:
a collision detection device, connected to the WAVE module through the in-vehicle device connection module, configured for providing a warning message to the WAVE module when the vehicle catches a collision event, wherein the WAVE module sends the WAVE announcement frame to the at least a neighboring vehicle to notify the collision event.
